(19) United States
(12) Patent Application Publication
(10) Pub. No.: US 2019/0242647 A1
(43) Pub. Date: Aug. 8, 2019

(54) Method for Drying Scarfed Veneers

(71) Applicant: Hanses Sägewerkstechnik GmbH & Co. KG, Meschede-Remblinghausen (DE)

(72) Inventor: Josef Hanses, Meschede-Remblinghausen (DE)

(73) Assignee: Hanses Sägewerkstechnik GmbH & Co. KG, Meschede-Remblinghausen (DE)

(21) Appl. No.: 16/318,484

(22) PCT Filed: Jul. 5, 2017
(86) PCT No.: PCT/EP2017/066830

§ 371 Date: Jan. 17, 2019

(30) Foreign Application Priority Data
Jul. 22, 2016 (DE) 10 2016 113 556.9

(51) Int. Cl. F26B 15/12

(52) U.S. Cl. CPC F26B 15/12; B27D 5/00

(57) ABSTRACT

A method of drying scarfed veneers, wherein the veneers pass through a drying furnace, wherein the scarfed edges (42) of the veneers are moistened before they enter into the drying furnace (24).

The invention relates to a method for drying scarfed veneers, in which the veneers pass through a drying furnace.

DE 887 702 C describes a method in which the veneers which are used for example for forming a laminated veneer lumber are scarfed at the edges of the veneer web directly at the time when the veneers are peeled. The term “scarfing” designates a processing step in which the edge of the veneer is chamfered by milling or grinding. In the later manufacture of laminated veneer lumber, the dried and glued veneer panels are laid to form an endless string which multiple layers wherein the buts are offset from layer to layer, whereafter the veneers are pressed and bonded in a continuous press under the action of pressure and heat. In this process, the veneer panels that follow one after the other in the same layer are butted such that their scarfed edges overlap. In this way one obtains a better joint between the veneer panels without creating an excessive material thickness in the zones of overlap.

In the methods that are common today, veneer panels are scarfed only after drying. The method of the type mentioned above, wherein the veneer is scarfed already prior to drying, however, has the advantage that the veneer is less brittle bevor it is dried, so that the scarfed edges are not likely to break out.

It is an object of the invention to improve the efficiency in drying the veneers, or to achieve a better quality of the veneers while keeping the efficiency high.

According to the invention, this object is achieved by the feature that the scarfed edges of the veneers are moistened before entering into the drying furnace.

The moistening step prevents that the scarfed veneers, in which the thickness of the yeneer decreases almost to zero, are burned in the drying furnace due to a high temperature. This opens the possibility to increase the temperature in the drying furnace, so that a higher throughput of the veneers becomes possible.

Useful details of the method are indicated in the dependent claims.

In advantageous embodiments, the scarfed edges are moistened by spraying water onto them.

The invention also relates to a system for carrying out the method according to the invention.

Embodiment examples will now be described in conjunction with the drawings, wherein:

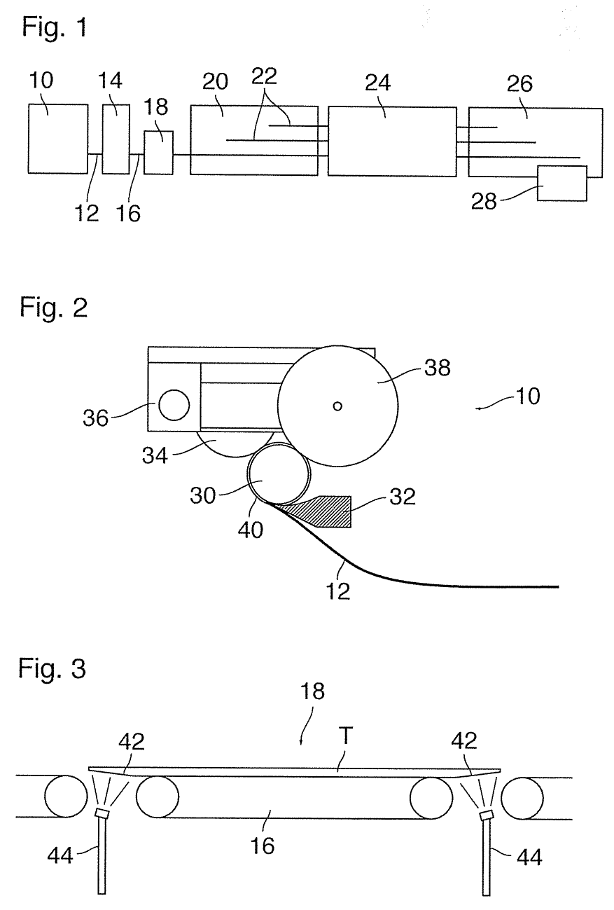

FIG. 1 is a block diagram of a plant for processing and drying veneers;

FIG. 2 is a sectional view of a processing stage for peeling and scarfing the veneers in the plant according to FIG. 1; and

FIG. 3 is a front view of a moistening station in the plant according to FIG. 1.

In the plant shown in FIG. 1, the veneer is peeled from a trunk in a processing stage 10 while the veneer web 12 being produced is scarfed at its longitudinal edges at the same time. Then, the veneer web passes through a cutting stage 14 in which it is divided into individual veneer panels, and the panels are rotated by 180° about the vertical axis. Then, the veneer panels are placed onto a conveyor 16 one after the other and are passed through a moistening stage 18 where the scarfed edges are moistened by spraying water onto them.

Downstream of the moistening stage 18, there is provided a loading device 20 in which the veneer panels are distributed onto conveyors 22 that are arranged one above the other in several layers and on which the panels are passed through a drying furnace 24 at reduced speed. The dry veneers are taken up from the conveyors 22 in an unloading stage 26 and are for example buffered in stacks 28 before they are processed further to form laminated veneer lumber.

The essential parts of the processing stage 10 have been shown in FIG. 2. A round timber 30, e.g. a tree trunk, is clamped between spindle sleeves with its opposite ends and is rotated about its longitudinal axis while a cutting knife 32 peels-off the veneer web 12 from the periphery of the trunk. The reaction forces of the peeling knife 32 are absorbed by pressure rollers 34 that roll on the periphery of the round timber 30. At each end of the round timer a movable milling head 38 is mounted on a carrier 36 which carries also the pressure rollers 34, the milling head being held in a defined position relative to the peripheral surface of the round timber 30 by means of a follower roll that is not visible in the drawing, and the milling head produces a chamfer 40 at the peripheral edge of the round timber 30. The peripheral layer of the round timber in which the chamber 40 has been formed is then peeled-off by means of the peeling knife 32 and forms the veneer web 12, wherein the chamfer 40 forms a scarfed edge 42 (FIG. 3) of the veneer web.

FIG. 3 is a side view of the moistening stage 18. The veneer web 12 has been divided into individual veneer panels T in the cutting stage 14, the panels being disposed on a section of the conveyor 16 in such a manner that the scarfed edges 42 that result from the chamfers 40 face downwards and project at the upstream end and at the downstream end of the conveyor section. The conveyor 16 is operated intermittently, and during a stop of the conveyor, the scarfed edges 42 are sprayed with water from spray nozzles 44. Immediately thereafter, the veneer panels T, with the edges 42 still being wet, enter into the drying furnace 24. In the drying furnace, the decrease of thermal energy due to the evaporation of the water from the scarfed edges 42 protects these edges from being burned.

In a modified embodiment, the moistening stage 18 may also be integrated into the loading stage 20 and may have spray heads that are arranged at the individual conveyors 22. In that case, the edges 42 are moistened only directly before the entry into the drying furnace 24. This makes it also possible, for example, to remove the veneer panels from the conveyor 16 and to stack them in buffer stacks by means of the loading device 20 before they are moistened.

What is claimed is:

1. A method of drying scarfed veneers, comprising the steps of:
passing veneers having scarfed edges through a drying furnace, and
moistening the scarfed edges of the veneers before they enter into the drying furnace.

2. The method according to claim 1, wherein said step of moistening includes the step of moistening the scarfed edges by spraying water onto them.

3. The method according to claim 1,
wherein the scarfed edges of the veneer are longitudinal edges that extend in a transport direction of the veneers, and
further including the step of passing one of:
a veneer web or
individual veneers continuously through a moistening stage.

4. A device for carrying out the method according to claim 1, comprising:
a drying furnace,
a conveyor for transporting the veneers through the drying furnace, and
a moistening stage for moistening the scarfed edges of the veneers upstream of the drying furnace.

5. The device according to claim 4, further comprising, upstream of the moistening stage, a processing stage for peeling and scarfing the veneers.

6. The device according to claim 5, further comprising a cutting stage for dividing a veneer web into individual veneers between the processing stage and the moistening stage.
